(19) United States
(12) Patent Application Publication
(10) Pub. No.: US 2016/0263804 A1
(43) Pub. Date: Sep. 15, 2016

(54) METHOD FOR PRODUCING AN CONTINUOUS FILM WITH A BLOWN FILM LINE

(71) Applicant: REIFENHÄUSER GMBH & CO. KG MASCHINENFABRIK, Troisdorf (DE)

(72) Inventors: Edgar GANDELHEIDT, Worms (DE); Christoph LETTOWSKY, Aachen (DE)

(21) Appl. No.: 15/029,527

(22) PCT Filed: Oct. 9, 2014
(86) PCT No.: PCT/DE2014/000496

§ 371 Date: Apr. 14, 2016

(30) Foreign Application Priority Data
Oct. 15, 2013 (DE) 10 2013 017 111.3

(51) Int. Cl. B29C 47/00; B29C 47/92; B29C 47/86; B29C 47/06; B29C 47/20

(52) U.S. Cl. CPC B29C 47/0057; B29C 47/0026; B29C 47/065; B29C 47/20; B29C 47/866; B29C 47/92; B29C 2947/92209; B29C 2947/92704; B29C 2947/92904

(57) ABSTRACT

A method for producing a continuous film with a flow film line includes the steps of actively heating an annular nozzle at an outlet via a first tempering component in reference to the inflowing plastic melt such that the exiting plastic melt is heated. While the melt channel system upstream is actively cooled via a second tempering component in referent to the inflowing plastic melt such that the plastic melt flowing along is cooled in the direction towards the annular nozzle. This leads to a stable film because the absolute temperature of the plastic melt is not rising to critical ranges. Simultaneously, melt fractures are avoided when the blow head is heated at its outlet from the annular nozzle.

### CROSS-REFERENCE TO RELATED APPLICATIONS

This application is related to and claims the benefit of German Patent Application No. DE 10 2013 017 111.3, filed on Oct. 15, 2013, and PCT Application No. PCT/DE2014/000496, filed on Oct. 9, 2014, the contents of which are herein incorporated by reference in their entirety.

### TECHNICAL FIELD

The disclosure relates to a method for producing a continuous film with a blown film line, a method for producing a multi-layer continuous film, as well as a blown film line implemented for this purpose.

### BACKGROUND

Blown film lines are proven technology for the production of continuous film tapes. An extruder melts the plastic and provides plastic melt for further processing. It is accepted from a blow head as the technological heart of the blown film line. The plastic melt is initially divided in the blow head. For this purpose, a pre-distributor is provided. The pre-distributor ends in a spiral mandrel distributor. In the spiral mandrel distributor the individual strands of the pre-distributor are placed over top of each other free from seams to the extent possible. Here, a single-layer or multi-layer placement of the plastic melt and thus the layers in the end product, i.e. the film, may be provided. At the spiral mandrel distributor, which usually is used either as an axial spiral mandrel distributor, cylindrical or conical, or a radial spiral mandrel distributor, also called plate spiral mandrel distributor, a diameter adapter is connected where necessary.

At the diameter adapter, otherwise at the spiral mandrel distributor, then a nozzle block follows, which includes a circular nozzle. Here, the plastic melt is ejected as molding material.

In an exemplary embodiment, preferred by the applicant, an axial spiral mandrel distributor is used, and the blow film is extruded from the bottom towards the top, thus against gravitational forces. For reasons of simplification, some of the following embodiments and explanations relate to such an embodiment, while all conventional spiral mandrel distributors shall be covered, here, and the person skilled in the art shall understand the statements, accordingly, as analogous where necessary.

In the above-mentioned preferred embodiment both the extruder and/or the plurality of extruders are placed on the floor of the production site or at least near the floor. The blow head is also on its device frame near the floor.

The plastic melt coming from the extruders is then divided into several discrete strands in the bottom part of the blow head, namely the pre-distributor. For this purpose, drilled channels are arranged at the bottom of the blow head. They directly lead into the lower start of spiral helices in the spiral mandrel distributor. In the initial sections of the helices they at least essentially assume their final angular position in reference to the horizontal and this way lead into the helical shape. The spirals lead into an annular gap, which widens with increasing height, in which the one-layer or multi-layer molding material is formed and here rises upwards. After the end of the spiral, perhaps a frustum-conical piece is provided with a widening or tapering, in order to allow feeding a circular nozzle with a diameter, which is not equivalent to the diameter of the annular channel around the spiral. At the top, then the block with the annular nozzle follows. Here, during operation of the blown film line the plastic melt exits as molding material in the form of a still essentially liquid film tube, so that by introducing air and by pulling upwards at the device a longitudinal and transverse extension of the film hose can be achieved.

The extruded film tube is more stable and the device can be constructed lower the cooler the plastic melt is when exiting the annular nozzle.

The temperature of the plastic melt is essentially determined by the extruder. The largest part of the thermal energy is caused by the shearing or kneading in the extruder. During extended operation, accordingly the blow head at least essentially assumes the temperature of the melt flowing through. Common temperatures in practice amount however for the plastic melt to 180° C. or more, when exiting the extruder. At the latest when (materials at) temperatures far exceeding 200° C. flow into the blow head, the molding material exiting at the annular nozzle is still very liquid. This may lead to instabilities of the film hose as well as other difficulties during processing.

DE 101 22 856 B4 shows a film blow head with an external cooling ring and with bore holes in the blow head, in which heating cartridges are integrated, distributed over the circumference.

DT 68373 discloses a temperature control, in which the material of the nozzle surrounding the molten polymer is kept at a temperature from 100° C. to 180° C.

DE 32 11 833 C2 describes axially different zones with an annular gap compensating the temperature difference.

DE 10 2007 027 280 A1 suggests an additional cooling ring above the blow head but below an air cooling ring, to be contacted by the blow film hose and cooled, here.

The disclosure is based on providing an alternative or an improvement over conventional spiral mandrel distributors.

### SUMMARY

According to a first aspect of the disclosure this solution provides a method for producing a continuous film with a blown film line, with the flow film line comprising an extruder and following in the machine direction a blow head, with the extruder providing a plastic melt and the blow head providing a melt channel system with a pre-distributor, a spiral mandrel distributor, if necessary a diameter adapter, and an annular nozzle in an annular nozzle block, and with the blow head showing a tempering means acting upon the melt channel system, with the annular nozzle being actively heated at the exit in reference to the inflowing plastic melt by a first tempering means, and this way the exiting plastic melt is heated, while the melt channel system upstream in reference to the annular nozzle is actively cooled in reference to the here inflowing plastic melt via another tempering means, and this way the plastic melt flowing along in the direction towards the annular nozzle is cooled here.

The following explanations relate to terminology:

The production of the “continuous film” is not conditional to the product generated leaving the equipment as a continuous film tape. Rather, initially an extrusion as a continuous film can occur, and the film hose can still be separated in the arrangement. In most cases, actually the film hose is rolled up either in the form of a hose or cut open as a double-layer film tape, and leaves the arrangement in this fashion.

The “machine direction” represents the traveling direction of the plastic melt, coming from the extruder through the blow head towards the annular nozzle, thus in the sequence pre-distributor, spiral mandrel distributor, if necessary diameter adapter, annular nozzle block, and annular nozzle.

The “melt channel system” represents the channel system, continuously connected to each other, with the plastic melt flowing through the blow head.

A “tempering means” represents any means implemented for the active heating or cooling of the melt channel system. Here, particularly thermoelectrically heatable or coolable elements are referred to, which are characterized in any case in that they are connected electrically to a central control unit. Alternatively or cumulatively, a channel system with lines is intended for guiding the fluid, for example for a heating fluid or a cooling fluid.

It is hereby pointed out that within the scope of the present application, for reasons of simplified readability, primarily “controls” are discussed. This shall comprise “controlling” as a special case, respectively.

It is hereby explicitly pointed out that within the scope of the present disclosure any indirect articles, such as “one”, “two”, etc. generally shall be understood as minimal statements, thus “at least one . . . ”, “at least two . . . ”, unless at a certain position it is discernible from the context that here only “precisely one . . . ”, “precisely two . . . ” etc. are referred to.

The “exit” is the area in which the annular nozzle opens towards the environment, thus at which the plastic melt exits the blow head as molding material. The word “at the exit” indicates that several centimeters of the annular nozzle shall actively be heated upstream in reference to the actual end of the metal using a first tempering means. The plastic melt leaves the annular nozzle with a higher temperature than the plastic melt in the previous section, thus at the area traveling towards the annular nozzle. The presented aspect of the disclosure is based on the acknowledgment that any cooling down of the blow head and thus the plastic melt leads to the plastic melt exiting the annular nozzle as a more stable film hose. Simultaneously a melt fracture cannot be excluded, though.

In simple words, the disclosure therefore provides to cool the plastic melt indeed in the blow head; but then just upon exiting and in the short section upstream thereof a heating process occurs, which in turn acts upon the plastic melt. Prototype experiments of the inventors have shown that by the targeted heating of the lateral surfaces of the flow the risk of any melt fracture can be considerably reduced.

The experiments of the inventor have shown that particularly good results are achieved when the annular nozzle is heated via the first tempering means at both sides, thus radially inside and on the side of the annular nozzle gap located radially at the outside.

The annular nozzle should preferably be heated via the first tempering means over its circumference, either continuously or discontinuously. In a particular form of control or regulation the circumference of the annular gap may be adjusted to different segments. This way, for example the thickness profile of the exiting film hose can be influenced.

In order to attain the goal to allow for the plastic melt exiting the annular nozzle overall in a cooler condition than at the time when coming from the extruder and entering the pre-distributor, it may be provided for a particularly easy embodiment that the melt channel system is cooled for a longer distance than heated. In particular, it may even be considered to cool the melt channel system over the overwhelmingly largest part of the flow path for the plastic melt, for example at least over half of it, at least over ⅔, at least ¾, at least 90%, or even over 95% of the path. The plastic melt can here be cooled gently, while it is heated only at the last section of its flow path in order to allow exiting the annular gap in a more secure fashion.

Alternatively or cumulatively it is possible that the temperature difference between the heating first tempering means and the inflowing plastic melt is greater than the temperature difference between the first cooling tempering means and the here inflowing melt and/or the temperature difference between the last cooling tempering means and the here arriving melt. In case of a high temperature difference of the heated first tempering means just ahead of the exit from the annular nozzle the surface of the plastic melt can be rapidly heated, thus the area which contacts metal. Therefore it is not necessary to fear that here excessive adhesion effects occur.

When the melt channel system upstream in reference to the heating first tempering means is differently tempered along the machine direction with a plurality of tempering devices in a plurality of sections, here the melt quality when exiting can be influenced very well. Additionally, respectively ideal temperature ranges can be adjusted or even set for the individual sections of the flow path of the plastic melt, thus in the pre-distributor, in the spiral mandrel distributor, if necessary in the diameter adapter, and ultimately in the annular nozzle block on the path towards the annular nozzle. Additionally, it is possible for example that in the spiral mandrel distributor a higher temperature should be given than in the diameter adapter, because in the spiral mandrel distributor it must still be ensured that the individual layers of a multi-layer film or even a single-layer film come to rest on each other as free from seams as possible. This can generally be ensured more safely at higher temperatures. However, when flowing through the diameter adapter or mostly however the annular nozzle block the individual layers generally lie on top of each other, so that cooling can occur here in a particularly targeted fashion already in the desired form without considerably risking the homogeneity of the film or the film compound.

Preferably the melt channel system is differently cooled in precisely two, at least two, precisely three, at least three, precisely four, or at least four sections. Different cooling is achieved here in that the tempering means provide the metallic blow head with different temperatures in the various sections.

In particular, it is intended to cool the melt channel system at the pre-distributor, at the spiral mandrel distributor, at the diameter adapter, and/or at the annular nozzle block.

A tempering means is preferably controlled via a temperature sensor at or in the melt channel system, with preferably a temperature corridor being predetermined for the respective temperature sensor and/or a relative temperature and/or a relative temperature corridor being predetermined for a section of another tempering means. It is particularly beneficial to predetermine the relative temperature and/or the relative temperature corridor for the directly previous section. For example, it may be provided that the blow head in the annular nozzle block is adjusted for example to approximately 140° C. to 150° C., while the nozzle outlet itself is heated for example with 190° C.

It is considered advantageous for an embodiment to cool the annular nozzle block to the coolest temperature of the melt channel system. Alternatively, it shall be considered to cool the diameter adapter to the coolest temperature of the melt channel system, with preferably the annular nozzle block being cooled to the second-coldest temperature of the melt channel system.

When a multi-layer continuous film is produced, here according to a second aspect of the present disclosure it is suggested that the channel is stronger cooled at its guide for a central layer than at a guide for an outer layer.

With regard to terminology, a “central” layer is already provided in reference to an “outer” layer when the central layer is located inside the film and the outer layer further towards the outside. In the meantime, most films are designed symmetrically. In the simplest case therefore a central layer is given and two outer layers, which are actually located outside at the film. The outer layer not necessarily represents the outermost layer, but it may also form an outer layer in reference to the central layer.

According to a third aspect of the present disclosure a blown film line is provided with the blown film line if necessary comprising an extruder and downstream in reference to the machine direction a blow head, with the extruder being embodied during operation to provide a plastic melt and the blow head being embodied to process the plastic melt, and for this purpose a melt channel system showing a pre-distributor, a spiral mandrel distributor, perhaps a diameter adapter, and an annular nozzle in an annular nozzle block, and with the blow head showing a plurality of tempering means acting upon the melt channel system, as well as a device control, which is equipped to act upon the tempering means and embodied for implementing a method according to the present aspects.

In order to allow influencing the temperature in a targeted fashion, it is suggested as a constructive measure that tempering channels are provided in the blow head, namely showing an electric heating means, comprising an electric cooling means and/or connected to a fluid guide with a pump for a heating fluid and/or a cooling fluid.

### BRIEF DESCRIPTION OF THE DRAWINGS

In the following, the disclosure is explained in greater detail based on an exemplary embodiment with reference to the drawing.

FIG. 1 is a schematic cross-section through a blow head of a blown film line with five sections that can be individually temperature controlled.

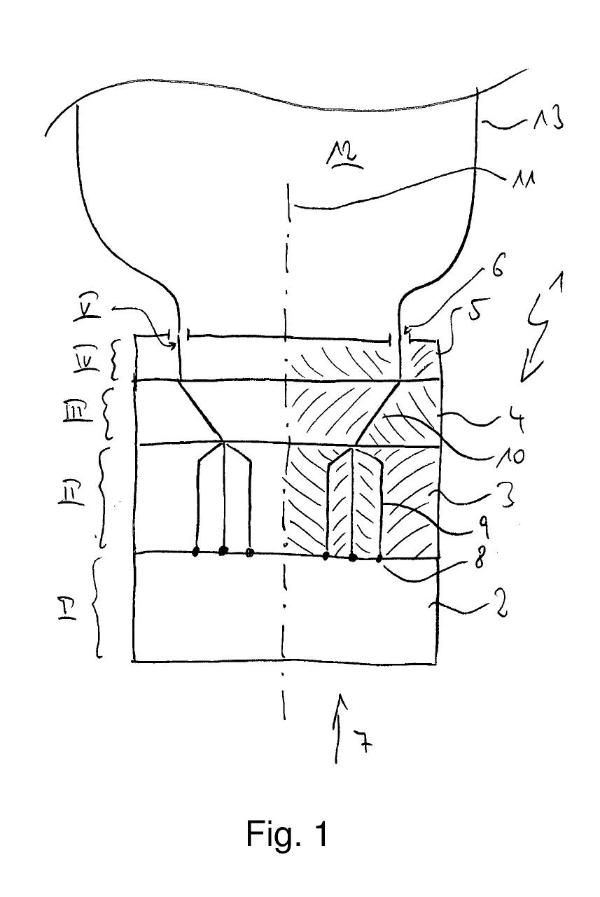

### DETAILED DESCRIPTION OF THE DRAWINGS

The blow head 1 in the FIGURE essentially comprises four stages: a pre-distributor 2, a spiral mandrel distributor 3, a diameter adapter 4, and an annular nozzle block 5 with a circular annular nozzle 6.

In a machine direction 7, the blow head 1 is implemented such that plastic melt flows through it, coming from an extruder (not shown), namely entering via inlets (not shown) in the pre-distributor. Inside the pre-distributor, bores (not shown) lead to the starts 8 (numbered as examples) of spirals 9 in the spiral mandrel distributor 3. Here, the flow of the plastic melt separated in the pre-distributor is again united in the blow head 1 shown here in order to form a three-layer melt. The three-layer melt flows through an annular gap 10 in the diameter adapter 4 and this way widens the diameter of the flowing melt. With the widened diameter it enters the annular nozzle block 5 and leaves it at the annular nozzle 6 in the machine direction 7 extending upwards and circularly symmetrically about a longitudinal axis 11. Compressed air inside 12 of the molding material developing in the form of a blow film hose 13 leads to an extension of the molding material.

The presented embodiment of the blow head 1 shows a rather fine-tuned temperature control a the first section I, a second section II, a third section III, a fourth section IV, and a fifth section V. Each of the sections I to V can be temperature controlled individually via a control. For this purpose, respective tempering bores are provided in the metal of the blow head 1. Cooling liquids and heating liquids can flow through them. For this purpose, on the one hand pumps are provided (not shown). On the other hand, each of the stages Ito V show a temperature sensor (not shown) directly at the melt channel. Each of the temperature sensors is connected via data transmission to a device control. The device control in turn is effectively connected to the pumps or valves or heating and cooling means.

During operation of the blown film line comprising the blow head 1, the device control regulates the temperatures of the liquids flowing through the individual sections I to V such that the temperature of section I, is below the temperature of the plastic melt flowing in from the extruder. The temperature at the section II is for example equivalent or slightly lower than the temperature in section I. The temperature in section III is once more reduced in reference to section II. The temperature is further reduced in section IV in reference to section III. Here as well as in other embodiments it may also be provided to keep the temperature steady or slightly increase it. Finally, an internal and external gap heating is provided for the nozzle in section V, which increases the surface of the melt channel system here considerably above the temperature of section IV or anyway in reference to the temperature of section III, so that the plastic melt can exit easier as a formed body in the form of a blow film hose 13 without suffering any melt fracture when exiting the annular nozzle 6. In prototype experiments of the inventors melt fractures often developed when exiting the annular nozzle, for example at temperatures of approx. 160° C. This could be successfully remedied with the disclosure presented here.

1. A method for producing a continuous film with a flow film line, with the blow film line comprising an extruder and downstream in the machine direction a blow head, with the extruder providing a plastic melt and the blow head comprising a melt channel system with a pre-distributor, a spiral mandrels distributor, if necessary a diameter adapter, and an annular nozzle in an annular nozzle block, and with the blow head comprising a tempering means acting upon the melt channel system
wherein
the annular nozzle at the outlet being actively heated via a first tempering means in reference to the inflowing plastic melt and this way the exiting plastic melt being heated,
while the melt channel system upstream in reference to the annular nozzle being actively cooled via another tempering means in reference to the inflowing plastic melt and this way the plastic melt flowing along there is being cooled in the direction towards the annular nozzle.

2. The method according to claim 1, wherein the annular nozzle is heated at both sides via the first tempering means.

3. The method according to claim 1, wherein the annular nozzle is differently tempered at its exterior in reference to its interior via the first tempering means, primarily heated differently.

4. The method according to claim 1, wherein the annular nozzle is heated over its circumference via the first tempering means.

5. The method according to claim 1, wherein the melt channel system is cooled over a longer distance than heated.

6. The method according to claim 1, wherein the melt channel system is differently tempered upstream in reference to the first tempering means along the machine direction with a plurality of tempering devices in a plurality of sections.

7. The method according to claim 6, wherein the melt channel system is cooled in two sections.

8. The method according to claim 7, wherein the melt channel system is cooled in three sections.

9. The method according to claim 8, wherein the melt channel system is cooled in four sections.

10. The method according to claim 1, wherein the melt channel system is cooled at the pre-distributor, at the spiral mandrel distributor, at the diameter adapter, and/or at the annular nozzle block.

11. The method according to claim 1, wherein a tempering means is controlled via a temperature sensor at or in the melt channel system, with a temperature corridor being predetermined for the respective temperature sensor and/or a relative temperature and/or a relative temperature corridor being predetermined for a section of another tempering means.

12. The method according to claim 1, wherein the annular nozzle block is cooled to the coolest temperature of the melt channel system.

13. The method according to claim 1, wherein the diameter adapter is cooled to the coolest temperature of the melt channel system, with the annular nozzle block being cooled to the second-coldest temperature of the melt channel system.

14. The method according to claim 1, with a multi-layer continuous film being produced, wherein the channel system being cooled stronger at its guide for a central layer than at its guide for an outer layer.

15. A blow film line, with the blow film line-, if necessary, comprising an extruder and following thereto in the machine direction a blow head, with the extruder during operation being implemented to provide a plastic melt, and the blow head being implemented to process the plastic melt, and for this purpose the melt channel system comprising a pre-distributor, a spiral mandrel distributor, if necessary a diameter adapter, and an annular nozzle in an annular nozzle block, and with the blow head showing a plurality of tempering means acting upon the melt channel system, as well as a device control, which is embodied to act upon the tempering means and is embodied to perform a method according to claim 1.

16. The blow film device according to claim 15, wherein tempering channels are provided in the blow head, namely with an electric heating means, with an electric cooling means and/or connected to a fluid guide with a pump for a heating fluid and/or a cooling fluid.
